(19) United States
(12) Patent Application Publication
(10) Pub. No.: US 2004/0035804 A1
(43) Pub. Date: Feb. 26, 2004

(54) Separating device for separating fluids from solids and use thereof

(76) Inventor: Rudolf Bischof, Eching (DE)

Correspondence Address: STEVENS DAVIS MILLER & MOSHER, LLP, 1615 L STREET, NW, SUITE 850, WASHINGTON, DC, 20036, US

(21) Appl. No.: 10/311,979

(22) PCT Filed: Jun. 29, 2001
(86) PCT No.: PCT/DE01/02428

(30) Foreign Application Priority Data
Aug. 4, 2000 (DE) 10038079.4
Oct. 16, 2000 (DE) 10051204.6
Nov. 18, 2000 (DE) 10057269.3

(51) Int. Cl. C02F 1/00

(52) U.S. Cl. 210/770

(57) ABSTRACT

The invention relates to a separating device for separating fluids (18) from solids (31), in particular for the separation of fluids (18) from material previously isolated from a solid—fluid mixture (33), comprising:—a screw transport device (1), provided with a housing (2), a shaft (4) and a conveying helix (3), a compacting zone (15) wherein the solid conveyed by the screw transport device (1) is compressed to express the fluid, a sieve area (16), in particular on the compacting zone (15) and a solids discharge section (7) where the expressed solids are led away from the rotating axis of the screw transport device (1). According to the invention, the drainage effect may be improved, whereby a counter transport device (9) is provided for the transport of solids in a direction (10), opposed to at least one direction component of the transport device (8) on the screw transport (1), in such a way that solids in the compacting zone (15) and/or in the solids discharge section (7) are put under pressure by the counter transporting (10), in order to increase the expression force for the expression of fluids and the discharge force (P) for the discharge of expressed solids from the separating device. According to the invention, the drainage effect may be alternatively, or additionally improved, whereby the sieve surface (16) is formed at least partly on the shaft (4). Further, a preferred application of the above separating device in a mechanical effluent treatment is disclosed.

### FIELD OF THE INVENTION

The invention relates to a separator for separating liquid from solids, more particularly for separating liquid from stock previously extracted from a slurry, comprising:

a) a screw feeder provided with a housing, shaft and helical flight,

b) a compacting zone in which solids conveyed by the screw feeder are compacted to express the liquid,

c) a screen, more particularly at the compacting zone and

d) a solids discharge section at which expressed solids are removed from the axis of rotation of the screw feeder.

In addition, the invention relates to use of such a separator.

The separator in accordance with the invention is mainly intended for application in the field of mechanical effluent treatment in many municipal sewage treatment plants of which screening or raking systems are already in use integrated with a press zone, also termed dewatering zone. These machines separate solids from slurries, convey the stock by means of a screw feeder or helical flight and dewater the extracted material by pressing to then be ejected, for example, into a container. To save disposal costs the remaining stock is required to be as dry as possible.

### PRIOR ART

One example of such a separator is known from German patent DE 42 11 606 C1. In this known separator solids having collected on a screen located in the slurry are conveyed by means of a screw feeder including a housing, a shaft and a helical flight from the liquid phase upwards. Provided at the end of the feeder is a compacting zone in which the solids are dewatered, i.e. pressed to express the liquid. In the upper region of the screw feeder the housing translates into a discharge chute for ejecting the separated solids down into a container. The compacting zone is formed upstream in the region of the discharge chute adjoining the housing. In the compacting zone the solids are compacted into a plug. Compacting is enhanced by a shiftably rigidly or pliantly mounted counterpressure plate.

No indication reads from DE 42 11 606 C1 as to how the water expressed in compacting is drained, there merely being an indication of a screen—the extractor—at the start of the conveying section for screening the solids from the waste water.

The disadvantage in separators of the aforementioned kind known hitherto is that fresh water is needed in most cases to flush the press water discharge zone to prevent deposits and encrustations. The dewatering capacity of the separators of the aforementioned kind known hitherto is often unsatisfactory, i.e. the ejected remaining stock is still relatively moist, necessitating cost-intensive disposal. Apart from this, special requirements exist at the assembly site since containers for transporting the separated stock away need to be made available below the ejection zone.

### SUMMARY OF THE INVENTION

The invention is based on the object of providing a separator of the aforementioned kind having an enhanced dewatering capacity.

This object is achieved by a separator having the features as set forth in claim 1 and claim 9 respectively.

To achieve this object a separator of the aforementioned kind comprises a return feeder by means of which solids can be conveyed contrary to the conveying direction of the screw feeder to boost the pressure in the compacting zone and/or at the solids discharge section in thus increasing the forces in expressing the liquid or for ejecting the expressed solids from the separator. The return feeder—powered for example by means of a (motor) drive—generates a backpressure on the stock conveyed by the screw feeder in the direction of the solids discharge section, it being due to this backpressure that the conveyed solids have the tendency to deflect radially or tangentially from the longitudinal centerline of the shaft.

In this arrangement it is not necessary that the return feeder returns the solids parallel to the conveying direction of the feed shaft. To boost the compression at any location, such as for example in the compacting zone and/or at the solids discharge section, it is sufficient when at this location the direction of the return feeder is oriented opposing the conveying direction by at least one directional component

Simply increasing the pressure already enhances the expressing and thus dewatering effect. In addition, due to aforementioned radial or tangential forces, expressed stock can be transported in a new direction—tangentially or radially to the longitudinal centerline of the feeder in thus making it possible to eject the expressed stock not only downwards or slantingly downwards. Now, the stock—with a corresponding additional force—can also be discharged to the side, slantingly upwards or even vertically upwards.

This has the advantage that there is now more freedom in configuring the footprint of the separator since it is no longer a mandatory requirement for the container to be locatable directly below the upper end of the screw feeder.

However, for other reasons too, especially as regards effective dewatering, it may be of advantage to eject the stock to the side or upwards. Due to the force needed for ejection, the already expressed solids become piled up and further compacted due to friction and static pressure. The dwell time of the solids within the machine is now also longer which additionally improves the result of dewatering, in other words the configuration in accordance with the invention now makes after-dewatering possible.

In addition the return feeder permits attaining improved discharge of solids even when the remaining configuration is conventional.

However, yet a further improvement in dewatering is attainable additionally or alternatively in accordance with the invention by comprising the shaft with the screen or an additional screen for extracting the liquid discharged or expressed from the solids.

If, namely the stock were to be dewatered via an outer screen shell this could become blind by solids already expressed further outwards, because of the press effect, resulting in the disadvantage of solids located further inwards failing to be liberated from the liquid despite strong compression. Now, for the first time, the invention eliminates this disadvantage by the shaft being provided with the, or with a, screen in thus permitting removal of water or other liquid from the more internal portions of the solids.

Advantageous aspects of the invention are the subject matter of the sub-claims.

To advantage, the shaft is configured as a perforated quill shaft, more particularly as a tube open at the bottom end and featuring screening perforations. In accordance with one particularly preferred embodiment a perforated tube open at the bottom end connected to the drive shaft and forming the latter is provided within the helical flight and which may also be termed screw core tube. The screw core tube is provided preferably only within the topmost portion of the helical flight, for example, within the topmost two to five flights thereof. In this arrangement the helical flight is secured to the screw core tube, preferably welded thereto, whilst continuing to serve preferably as part of the shaft for communicating the torque from a drive unit to the helical flight. The screw core tube permits discharge of the expressed water from the center of the solids located in the compacting zone which is often also termed “press cake”. The expressed water flows through the bottom opening of the tube, via the flutes in the helical flight or between the outlets thereof and the inner side of the feed tube back into the lower solids extraction zone where the solids are extracted from the liquid phase at the extractor. The expressed water then flows via the screening perforations provided there further into the discharged liquid flow whereby any solids entrained in the expressed water are held back directly.

By providing the shaft with a screen—especially on smaller separators of less diameter—there is now no need for an outer perforated shell incorporating a flushing means. By providing a core tube with screen perforations enhanced dewatering results can also be achieved with a separator featuring an outer perforated shell.

A variety of return feeders is conceivable suitable for boosting the pressure on the press cake. Since because of the screen screw a rotary drive is provided in any case, preference is given to return feeders having conveyor screw surfaces or return feeders screw-type or similar axial return feeders permitting conveyance axial to an axis of rotation. Although conveyor screw surfaces provided for the return feed, termed first conveyor screw surfaces in the following, may be configured in the same sense as the feed helical flight so that return feed is then achieved by a rotation in the opposite sense, by configuring at least one screw surface of the return feeder opposite in sense to the feed helical flight return feed can be achieved by rotation in the same sense. Then, the feed helical flight and the screw surface can be arranged on shafts powered in the same sense in common and more particularly even on one and the same shaft which is particularly simple to engineer. In one preferred embodiment a common shaft is configured such that it extends beyond the feeder helical flight which for this purpose ends, for example, already upstream of the solids discharge section whilst the shaft extends beyond this. Preferably the return feeder—arranged to advantage at least in part downstream in the solids discharge section as viewed in the conveying direction of the helical flight so as to to return solids conveyed beyond the the solids discharge section back thereto—is a helical or propeller-type return feeder element on this shaft. This may be a screw-type conveyor vane configured for return feed, termed return feeder vane in the following, or it may be a helical flight segment configured for return feed, termed first helical flight segment in the following, or as may be further preferred a plurality of such return feeder elements. The pitch of the first screw conveyor flight of the return feeder may remain constant in this arrangement. However, for compacting the solids to be returned it may also be provided for that the flank or axial screw height of the first screw conveyor flight reduces as viewed in the return conveying direction.

Some screw feeders extracting solids from a slurry are sometimes briefly operated “backwards”, rotating the helical flight contrary to the conveying direction, for cleaning purposes or for returning at least part of the solids from time to time. WO93/01000 discloses, for example, one such screw feeder to which express reference is made also as regards further special aspects substantial to the present invention, more particularly as regards the configuration of the conveyor as well as its control, mode of operation and use. With a return feeder coupled to the feeder shaft or its drive, reversing the direction of rotation would result in solids located in the return feeder being conveyed in the conveying direction which is precisely the opposite to what is desired for solids already conveyed beyond the solids discharge section. This is why in one aspect of the invention, adapted for brief return operation of the screw feeder, a conveying element assigned to the return feeder is provided which even when the helical flight is rotated contrary to the conveying direction of rotation ensures that solids already beyond the compacting zone and/or the solids discharge section as viewed in the conveying direction are returned thereto. For this purpose it would be conceivable, for example, to provide a device for reversing the inclination of the first screw conveyor flight when reversing the direction of rotation of the separator. However, this would be relatively complicated in design and require intensive maintenance. Instead, preference is given to providing the return feeder, for one thing, with at least one return feeder element configured with the first screw conveyor flight oriented opposite to the feeder helical flight for returning solids in the direction of the return feed on rotation of the shaft in the feeding direction and, for another, in addition at least one of these conveyor elements. The conveyor element could be, for example, an axial feed element provided with a second screw conveyor flight oriented in the same sense as the feeder helical flight. In one preferred aspect the first helical flight segment—in the form of half a helical winding—oriented in the opposite sense to the feed helical flight is provided on the shaft for forming a return feeder active as such in two directions over half of the shaft length. On the other half of the shaft length there is provided a second helical flight segment—in the form of half a helical winding configured mirror-inverse to the first helical flight segment—oriented in the same sense as the feed helical flight arranged as a feed element such that the ends in each case translate in contact with each other so that no stock is able to gain access downstream past the free ends of the return or feeder elements as viewed in the conveying direction.

### BRIEF DESCRIPTION OF THE DRAWINGS

Example aspects of the invention will now be detailled with reference to the attached drawings in which

FIG. 1 is a partly fragmented, diagrammatic side view of a first embodiment of a separator for separating liquid from solids as configured at the upper end portion of a feeder screw for discharging solids extracted from waste water for treatment;

FIG. 2 is a sectioned side view of a second embodiment of such a separator;

FIG. 3 is a section taken along the line III-III as shown in FIG. 2;

FIG. 4 is a plan view on a feeder screw shaft used in the separator as shown in FIG. 2;

FIG. 5 is a sectioned side view of a third embodiment of such a separator;

FIG. 6 is a section taken along the line VI-VI as shown in FIG. 5; and

FIG. 7 is a plan view on a feeder screw shaft used in the separator as shown in FIG. 5.

### DETAILLED DESCRIPTION

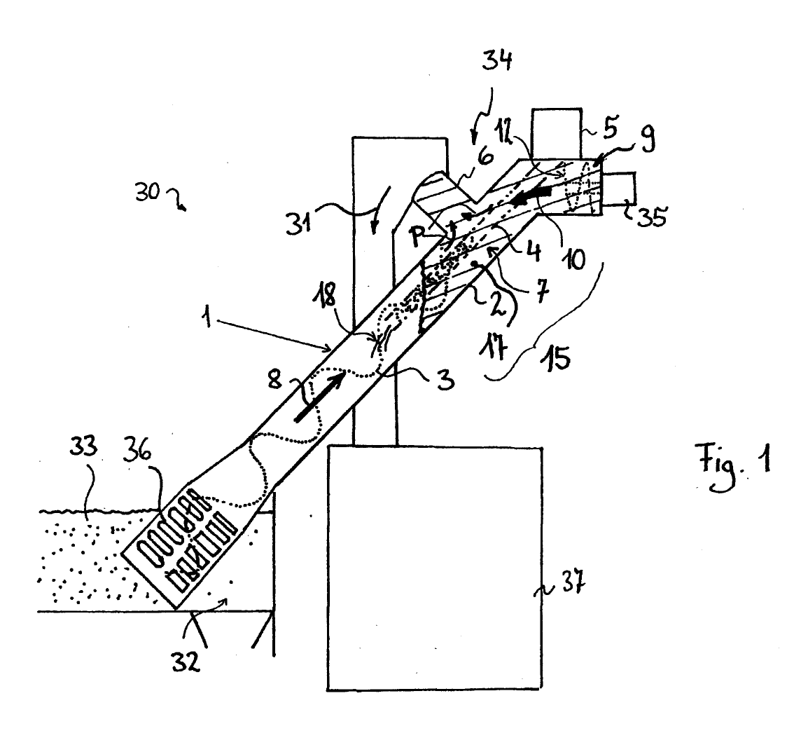

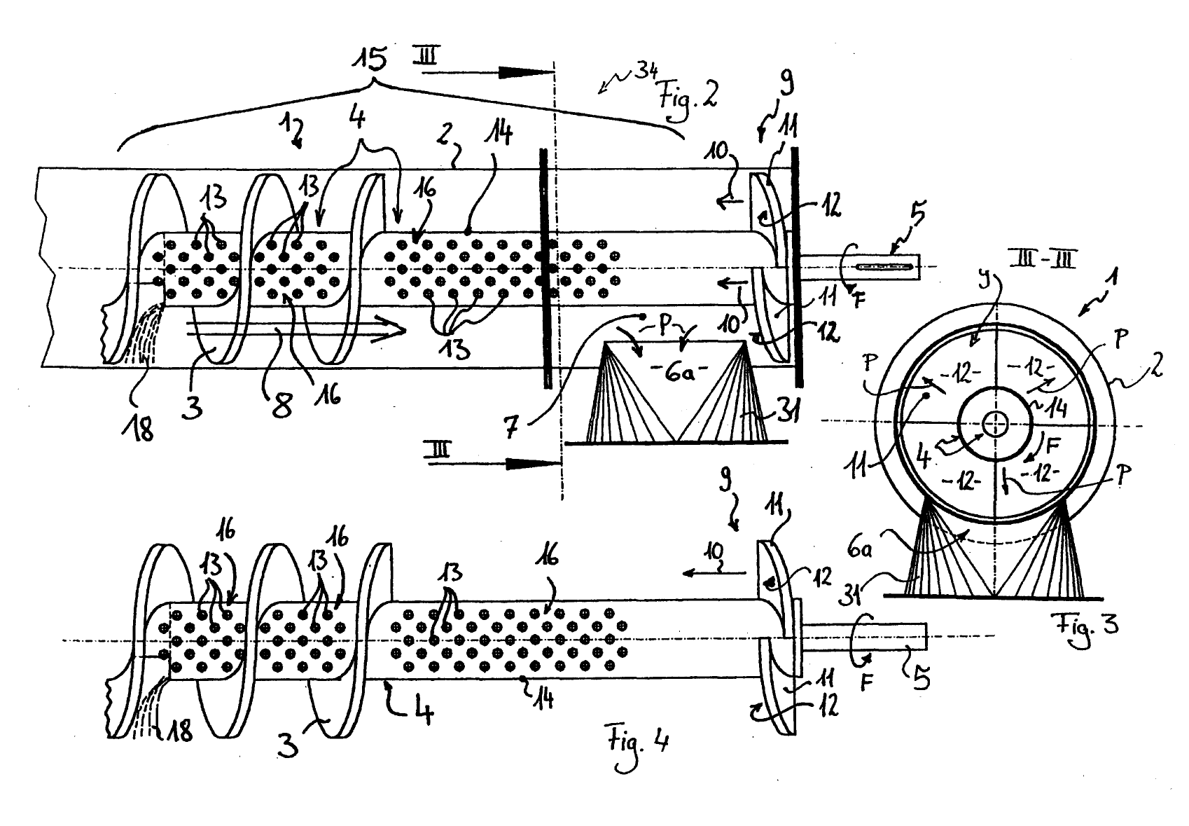

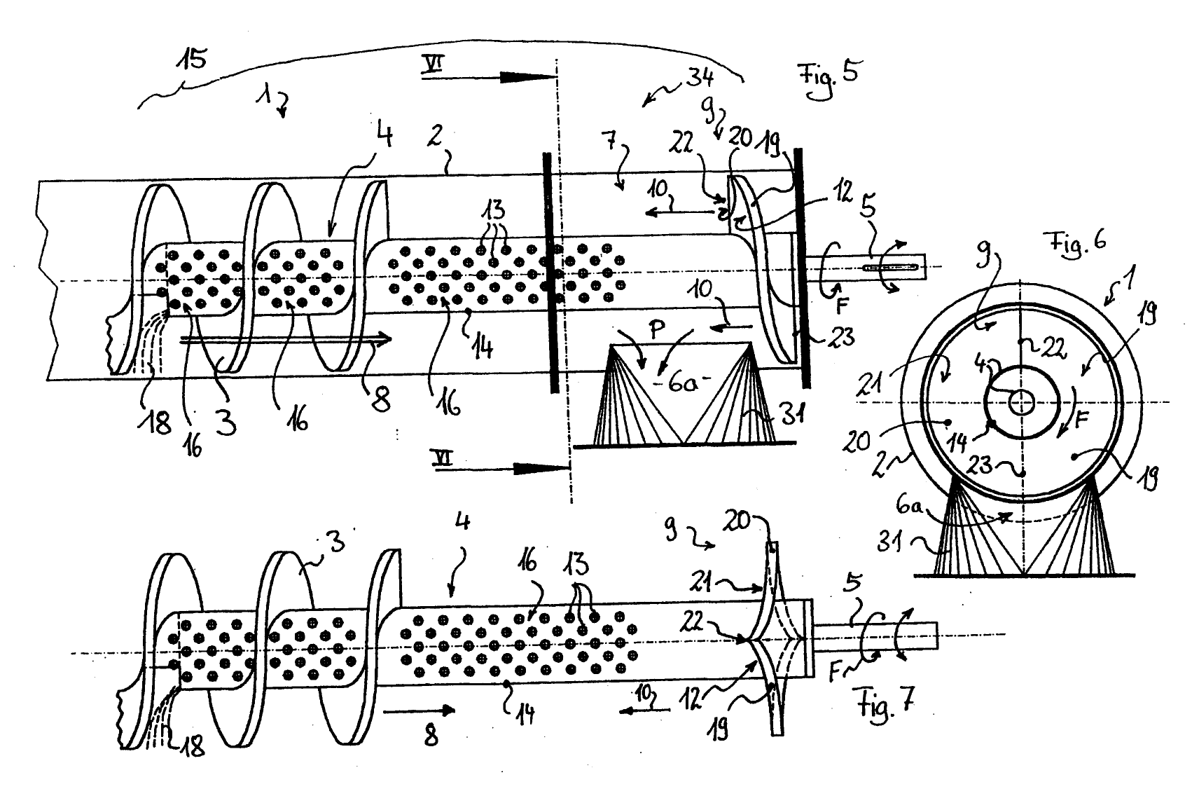

FIGS. 1, 2, 3, 5 and 6 each show fully or in part a screw feeder 1 as part of a slurry separator 30 for optimum separation of solids 31 and liquid 18, 32 of a slurry 33. The separator 30 may be used to extract e.g. solids from waste water. As regards the general configuration of separators 30 provided with screw feeders 1 express reference is made to DE 42 11 606 C1. The novelty as described presently is mainly directed at means for implementing dewatering of the extracted solids, i.e. more particularly dewatering solids as filtered or screened from waste water. For this purpose the discharge zone 34 as shown separately in FIGS. 2 and 5, i.e. the end portion of the feed section of the separator 30, is configured as the separator for separating the liquid from the solids.

The screw feeder 1 comprises a housing 2, a helical flight 3 and a shaft 4. The shaft 4 is connected to the gearing of a drive unit 5 for rotating the helical flight 3.

Referring now to FIG. 1 there is illustrated an embodiment in which the housing 2 is provided with an ejection tube 6 through which the solids 31 can be ejected from the separator. The ejection tube 6 defines a solids discharge section 7. In the embodiment as shown in FIG. 1 the ejection tube 6 is arranged on the side and/or projecting upwards from the housing 2.

In the example aspects as shown in FIGS. 2 to 7 instead of the ejection tube 6 a disscharge opening 6a defining the solids discharge section 7 open downwards for ejecting the solids 31 is provided in the housing 2.

As evident from FIGS. 2 and 5 the helical flight 3 ends, as viewed in the forward conveying direction 8 of the screw feeder 1, upstream of the solids discharge section 7. A return feeder 9, arranged fully or mainly downstream of the screw feeder 1, again as viewed in the forward conveying direction 8, is provided for conveying the further solids feed in a return conveying direction 10 oriented opposite the forward conveying direction 8.

In accordance with the example aspect as shown in FIG. 1 the return feeder 9 is formed by a feed screw configured separate from the shaft 4 and helical flight 3 and including its own drive unit 35.

By contrast, in the embodiments as shown in FIGS. 2 to 7 the return feeder 9 comprises at least one return feeder element extending radially outwards from the shaft 4 in the form of a helical return vane 11 or a first helical segment 19.

The return feeder 9 comprises in each case conveyor screw surfaces 12, 21 oriented in the direction of the helical flight 3 and which similar to the effect of the helical flight 3 on rotation of the return feeder 9 impact the stock engaging therewith in the return conveying direction 10. Provided on the return feed elements 11, 19 are first conveyor screw surfaces 12 oriented opposingly helical to the helical flight 3 and which on rotation of the return feeder 9 in the conveying direction of rotation F of the helical flight 3 impact the stock engaging therewith in the return conveying direction 10.

The return feed elements 11, 19 are firmly seated at the common shaft 4 so that together with the helical flight 3 the return feed elements 11, 19 rotate when powered by the motor drive unit 5.

Referring now to FIGS. 2 to 4 there is illustrated an example aspect in which four return vanes 11 are provided, although any number of return vanes 11 may also be provided, whereas in the embodiment as shown in FIGS. 5 to 7 a first helical segment 19 is provided as the return feeder element together with a second helical segment 20 configured and arranged mirror-inverse to the first helical segment 19. The second helical segment 20 is provided with a second conveyor screw surface 21 helically configured the same as the helical flight 3 so that even when the shaft 4 is rotated contrary to the conveying direction of rotation F the solids located downstream of the solids discharge section 7 as viewed in the forward conveying direction 8 can still be conveyed in the return conveying direction 10.

The shaft 4 is either configured itself as a tube with screen perforations 13, i.e. screw core tube 14, or the shaft 4 includes an inner shaft (not shown) covered by a screen shell in forming channels for draining off the expressed water. In the (likewise not shown) embodiments the housing 2 is also provided with a screen shell.

In the example aspect as shown, the screw core tube 14 extends only within the topmost three windings of the helical flight 3 where they are secured to the screw core tube 14, more particularly welded thereto. Accordingly, the screw core tube 14 serves to communicate the torque from the drive unit 5 (indicated in FIGS. 2 to 7 merely by the stub of the shaft 4 connecting a geared motor) to the helical flight 3. In embodiments (not shown) the screw core tube 14 extends down to the lower end portion of the screw feeder 1 where it ends open. It is at this lower end portion of the screw feeder 1 that the liquid-solids phase or slurry 33 is located in operation from which the solids 31 is extracted by a extraction screen 36 entering into this phase or slurry 33 for discharge by the screw feeder 1.

In the region of the upper end of the helical flight 3 up to the return feeder 9 a compacting zone 15 is configured, within which the solids feed can be compacted so that any liquid 18 still retained therein is expressed.

Due to the configuration of the screw feeder 1 as described above, the ejection tube 6 to be arranged facultatively instead of or at ejection opening 6a may be optionally oriented. This now makes it possible to provide not only discharge to the side but also an arrangement discharging slanting or directly upwards. Likewise conceivable is the use of flexible discharge means, for example discharge hoses also directed to the side or upwards. Just as possible is a discharge pipe including an additionally screen.

The function of the devices as described above will now be detailled.

Solids 31 separated out by the extractor screen 36 are conveyed by the screw feeder 1, more particularly by the helical flight 3 thereof, up to the upper end portion, the press and discharge zone 34, where solids conveyed beyond the solids discharge section 7 are returned by the return feeder 9 in the return conveying direction 10. The returned solids are thus packed against the solids conveyed from further below by the helical flight 3 in thus compacted the solids located in the compacting zone 15 into an expressed and dewatered press cake 17.

The expressed liquid—press water 18—escapes through the screen perforations 13 in the surface of the shaft 4 configured as a screen 16 and is returned through the interior of the shaft, i.e. the interior of the screw core tube 14, downwards into the slurry 33. Any remaining solids in the liquid 18 are entrained in the backwash to the solids extraction zone in which solids are extracted from the slurry 33 where they are again trapped by the extraction screen 36 and discharged by the screw feeder 1.

Due to the return feed in the directions 10 and 8 the stock of the press cake has the tendency to deflect radially outwards as indicated by the arrows P. It is due to these deflection or ejection forces P that the stock of the press cake—the expressed solids—is urged through ejection tube 6 or ejection opening 6a. In the ejection tube 6 the stock is packed by the friction and because of the static pressure in this becoming further compacted. This packing action also causes enhanced compression in the compacting zone 15 which in turn results in further dewatering of the press cake 17. The stock is then discharged through the ejection tube 6 or ejection opening 6a into a container 37 (FIG. 1).

The embodiment as shown in FIGS. 5 to 7 is devised for temporary reversed operation of the screw feeder 1. When the shaft 4 is rotated contrary to the conveying direction of rotation F, for example for cleaning purposes or for returning solids to a washer (not shown) incorporated in the solids extraction zone, then it is not the first conveyor screw surface 12, as in forward feed, but the second conveyor screw surface 21 that impacts the engaging stock in the return conveying direction 10. The two conveyor screw surfaces 12, 21 merge into each other at their circumferential ends 22, 23 as evident from FIG. 7. It is in this way that stock never gains access beyond the circumferential ends 22, 23 downstream of the return feeder 9, neither in forward nor in reverse operation, despite the the helical segments 19 and 20 running opposingly.

### LIST OF REFERENCE NUMERALS

| | |
|---|---|
| 1 | screw feeder |
| 2 | housing |
| 3 | helical flight |
| 4 | shaft |
| 5 | drive unit |
| 6 | ejection tube |
| 6a | ejection opening |
| 7 | solids discharge section |
| 8 | forward conveying section |
| 9 | return feeder |
| 10 | return conveying direction |
| 11 | return vanes |
| 12 | first conveyor screw surface |
| 13 | screen perforations |
| 14 | screw core tube |
| 15 | compacting zone |
| 16 | screen |
| 17 | press cake |
| 18 | press water |
| 19 | first helical segment |
| 20 | second helical segment |
| 21 | second conveyor screw surface |
| 22 | forward helical segment circumferential ends |
| 23 | rear helical segment circumferential ends |
| 30 | separator |
| 31 | solids |
| 32 | liquid |
| 33 | slurry, more particularly waste water |
| 34 | press and discharge zone |
| 35 | reverse feeder drive unit |
| 36 | extraction screen |
| 37 | container |
| F | conveying direction of rotation |
| P | ejection forces |

What is claimed is:

1. A separator for separating liquid (18) from solids (31), more particularly for separating liquid (18) from stock previously extracted from a slurry (33), comprising:
a screw feeder (1) provided with a housing (2), shaft (4) and helical flight (3),
a compacting zone (15) in which solids conveyed by the screw feeder (1) are compacted to express the liquid (18), a screen (16), more particularly at the compacting zone (15) and
a solids discharge section (7) at which expressed solids (17) are removed from the axis of rotation of the screw feeder (1)
wherein a return feeder (9) is provided for conveying solids in a return direction (10) contrary to the forward conveying direction (8) of said helical flight (3) with at least one directional component such that the solids (17) located in said compacting zone (15) and/or said solids discharge section (7) are compressed by the return feed (10) in thus increasing the forces in expressing the liquid or the forces (P) for ejecting the expressed solids from said separator.

2. The separator as set forth in claim 1 wherein said return feeder (9) has at least one rotatably arranged first conveyor screw surface(12).

3. The separator as set forth in claim 2 wherein said at least one arranged first conveyor screw surface (12) is helically configured in the opposite sense of said helical flight (3).

4. The separator as set forth in claim 2 or 3 wherein said return feeder (9) comprises at least one a helical or propeller-type return feed element (11, 19) connected to said shaft (4) of said screw feeder (1) extending in the forward conveying direction (8) of said screw feeder (1) beyond said helical flight (3) or to a shaft of said return feeder (9) arranged preferably concentrically thereto for joint rotation, said first conveyor screw surface (12) being configured at said return feed element (11, 19).

5. The separator as set forth in any of the claims 1 to 4 wherein said helical flight (3) is rotatable contrary to the conveying direction of rotation (F) for cleaning purposes and/or for returning solids into a zone located at the start of the feeder length of said helical flight, such as a solids extraction zone, a wash zone, a vortex zone or the like, and said return feeder (9) is assigned a feeder element (26, 27) which when said helical flight (3) is rotating contrary to the conveying direction of rotation (F), conveys solids located downstream, as viewed in said forward conveying direction (8), of said compacting zone (15) and/or of said solids discharge section (7) in the direction of said compacting zone (15) and/or to said solids discharge section (7), more particularly in a return conveying action.

6. The separator as set forth in claim 5, more particularly also as set forth in claim 4 wherein said return feeder (9) comprises or preferably is configured as an axial feeder connected to said shaft (4) of said screw feeder (1) for joint rotation, and said axial feeder comprising in addition to a return feed element (11,12) configured in the opposite sense of said helical flight (3) such that it conveys solids on rotation of said shaft (4) in said conveying direction in said return conveying direction (10) also said feed element (26, 27) configured as an axial feed element (26) rotating in said same sense as said helical flight (3) particularly, as a helical or propeller-type axial feed element provided with a second conveyor screw surface (27) spirally configured in said same sense as said helical flight (3).

7. The separator as set forth in any of the claims 2 to 4 and/or as set forth in claim 6 wherein the flank or screw height of one, several or all of said conveyor screw surfaces (12) remains the same or is reduces as viewed in said return conveying direction (10).

8. The separator as set forth in any of the claims 1 to 7 wherein as viewed in said forward conveying direction (8) said helical flight (3) ends upstream of said solids discharge section (7) and/or as viewed in said forward conveying direction (8) said return feeder (9) is arranged downstream of said solids discharge section (7) for a return feed or return conveyance of solids located downstream, as viewed in said forward conveying direction (8) of said compacting zone (15) and/or of said solids discharge section (7) back to said compacting zone (15) and/or to said solids discharge section (7).

9. A separator for separating liquid (18) from solids (31), more particularly for separating liquid (18) from stock previously extracted from a slurry (33), comprising:
a screw feeder (1, 20) provided with a housing (2), shaft (4) and helical flight (3),
a compacting zone (15) in which solids (17) conveyed by said screw feeder (1, 20) are compacted to express said liquid (25),
a liquid permeable screen (16), particularly at said compacting zone (15), and
a solids discharge section (7) at which expressed solids are removed from the axis of rotation of said screw feeder (1, 20)
wherein said shaft (4) is provided with said screen (16) or at least part of said screen (16) is configured on said shaft (4).

10. The separator as set forth in any of the claims 1 to 9 wherein said shaft (4) is configured as a tube including screen perforations (13), and more particularly as a tube (14) open at a bottom end.

11. The separator as set forth in claim 10 wherein said screen perforations (13) are configured in the full or partial region of said compacting zone (15) on said shaft (4), preferably however not in the region of said solids discharge section (7).

12. The separator as set forth in any of the claims 1 to 11 wherein said solids discharge section (7) comprises an ejection tube (6) extending with a tangentially or radially directional component, especially extending horizontally and/or upwards, from said axis of rotation of said helical flight (3) by means of which said solids are urged through by the pressure of said opposingly rotating feeds (8, 10).

13. Use of said separator as set forth in any of the claims 1 to 12;
a) in a slurry separator (30) for extracting solids from a slurry (33), particularly in a press and discharge zone (34) of such a separator (30), for expressing any liquid still present in said extracted solids and/or
b) for dewatering solids extracted from waste water.
